(19) United States
(12) Patent Application Publication
(10) Pub. No.: US 2005/0010347 A1
(43) Pub. Date: Jan. 13, 2005

(54) Process for generating signal from a security warning system

(75) Inventor: Martin Kemmer, Pforzheim (DE)

Correspondence Address: CROWELL & MORING LLP;INTELLECTUAL PROPERTY GROUP, P.O. BOX 14300, WASHINGTON, DC, 20044-4300, US

(73) Assignee: PORSCHE AG, Stuttgart (DE)

(21) Appl. No.: 10/845,515

(22) Filed: May 14, 2004

(30) Foreign Application Priority Data
May 16, 2003 (DE) 103 22 207.3

(51) Int. Cl. B60R 22/00

(52) U.S. Cl. 701/45; 701/46

(57) ABSTRACT

A method and system output a signal of a seatbelt warning device, so that an acoustic signal is output when the ignition is turned on and the belt lock of at least the driver's seat is not engaged. The loudness and/or frequency of the acoustic signal of the seatbelt warning device is variable as a function of at least one operating parameter that influences the interior noise level inside the vehicle.

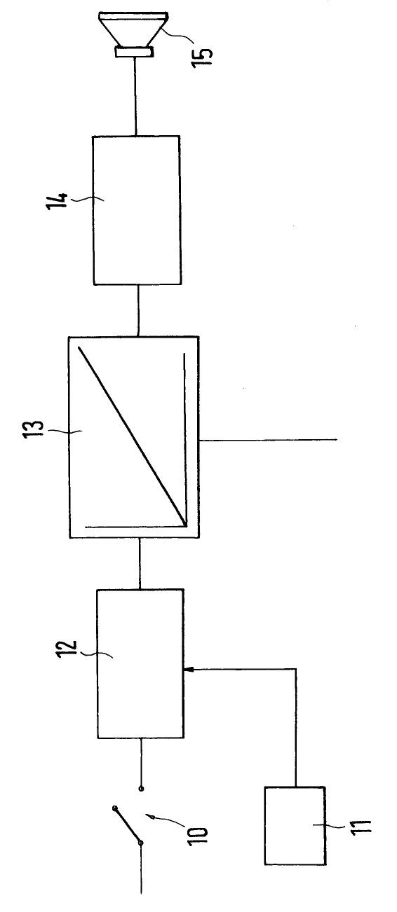

### BACKGROUND OF THE INVENTION

This application claims the priority of German patent document 103 22 207.3, filed 16 May 2003, the disclosure of which is expressly incorporated by reference herein.

The present invention relates to a seatbelt warning device of the general type described in DE 101 54 005 A1.

In the known device, a seatbelt warning device indicates that at least one of the seatbelts in the vehicle is not properly secured. A signal of the seatbelt warning device is output when the ignition is turned on, the vehicle speed is above a preselectable threshold and the fact that a vehicle seat is occupied but the seatbelt is not engaged is recognized. This known seatbelt warning device describes a repeatable warning option for reminding one or more of the occupants of the front passenger seat that they have forgotten to engage their seatbelts.

### SUMMARY OF THE INVENTION

An object of the present invention is to provide a method for output of a signal of a seatbelt warning device that advantageously adapts the loudness of an acoustic signal to the noise level prevailing in the vehicle. Amplification of the reminder signal for the seatbelt, also known as the seatbelt reminder, as a function of the prevailing interior noise in the vehicle ensures that this signal can be heard under all circumstances. At the same time, this also ensures that the signal will not be unreasonably loud for the occupants of the vehicle. The evaluation of the interior noise level on the basis of the prevailing operating parameters has the advantage that no additional microphone need be provided, so the function can be implemented especially easily because all the data is already available in the vehicle and need not be detected separately.

### BRIEF DESCRIPTION OF THE DRAWING

Other objects, advantages and novel features of the present invention will become apparent from the following detailed description of the invention when considered in conjunction with the accompanying drawings.

The sole FIGURE is a schematic diagram of the system for carrying out the method of triggering the seatbelt reminder system in accordance with the present invention.

### DETAILED DESCRIPTION OF THE DRAWING

The sole FIGURE is an overall depiction of the configuration of the individual parameters to be detected for the amplification of the signal of the seatbelt warning device. The ignition switch is shown schematically as switch 10, and the opened switch 10 denotes that there is yet no ignition signal. The seatbelt recognition unit is designated with reference numeral 11. In this unit 11, a check is performed to determine whether the seatbelt is engaged. As explained in detail in the prior art, analysis of the signals 10 and 11 sent to a signal generator 12 causes the warning signal to be output when the preselectable conditions for signal output are met. In the implementation according to the present invention described here, such a warning signal is output when the ignition is turned on and the seatbelt of at least the driver's seat has not been engaged.

A device 13 for evaluating the interior noise level in the vehicle is connected downstream from the signal generator 12. The interior noise level in the vehicle is based on operating parameters prevailing at the moment such as the vehicle speed, the engine rpm, the fan level, the fan rpm or the fan voltage. In the downstream amplifier 14, the seatbelt warning signal is adapted as a function of the evaluation of the interior noise level in the vehicle and the signal output at the output unit 15.

Evaluation of the interior noise level on the basis of operating parameters has the advantage that no additional microphone need be positioned in the interior of the vehicle. Instead, the amplifier factors may already be set in the application in an engine characteristics map that extends over the selected operating parameters and may be stored in the controller.

Because, for example, the air conditioning system in particular is responsible for relatively high interior noise levels associated with fan noise, especially after starting the vehicle on very hot days, evaluation of the fan rpm or the fan voltage therefore permits a rapid and simple adaptation of the loudness of the signal of the seatbelt warning device. The individual parameters for output of the amplifier signal can also be evaluated separately or in their totality, with the loudness of the radio in particular being taken into account as an important influencing parameter.

The seatbelt reminder signal can also be varied in frequency in addition to loudness, which provides even better security that the vehicle occupants will hear the acoustic signal even when the interior noise level is very high.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Method of outputting an acoustic signal of a seatbelt warning device in a vehicle, when an engine ignition is turned on and a belt lock of at least a driver's seat is in a disengaged state, and varying at least one of loudness and frequency of the acoustic signal of the seatbelt warning device as a function of at least one operating parameter that influences an interior noise level in the vehicle.

2. Method as claimed in claim 1, wherein the at least one operating parameter that influences the interior noise level in a vehicle include vehicle driving speed, engine rpm, fan level, fan rpm, fan voltage or loudness of a radio, where each of these operating parameters is evaluated separately or in combination with at least one other operating parameter.

3. System for outputting an acoustic signal in a seatbelt warning device in a vehicle, comprising a seatbelt recognition unit operable to determine if a seatbelt has been engaged, means for evaluating noise in the vehicle interior, and a signal generator for outputting a warning signal when an engine ignition signal is received and a seatbelt recognition signal has not been received, whereby the signal generator is operable to vary at least one of loudness and frequency of the acoustic signal of the seatbelt warning device as a function of at least one operating parameter that influences an interior noise level in the vehicle.

4. System as claimed in claim 3, wherein the at least one operating parameter that influences the interior noise level in a vehicle include vehicle driving speed, engine rpm, fan level, fan rpm, fan voltage or loudness of a radio, where each of these operating parameters is evaluated separately or in combination with at least one other operating parameter.
